(19) United States
(12) Patent Application Publication
(10) Pub. No.: US 2015/0214800 A1
(43) Pub. Date: Jul. 30, 2015

(54) SELF-SECURING BRAZING PREFORM CLIP

(71) Applicant: Remy Technologies, LLC, Pendleton, IN (US)

(72) Inventors: David Schuster, Indianapolis, IN (US); Ronald D. Gentry, Cicero, IN (US)

(21) Appl. No.: 14/163,296

(22) Filed: Jan. 24, 2014

(51) Int. Cl. H02K 3/28; H02K 15/02; B23K 1/00; H02K 15/00

(52) U.S. Cl. CPC H02K 3/28; H02K 15/0068; H02K 15/02; B23K 1/0016

(57) ABSTRACT

A method of assembling a stator includes forming a plurality of cleats into a brazing tape, forming a U-shaped clip using the stamped brazing tape, and attaching the U-shaped clip to a stator conductor, where the attached U-shaped clip is self-secured to the conductor by the cleats. Apparatus for connecting a stator conductor pair includes a brazing clip shaped to conform to and fit over one of the conductors and having generally a U-shape with two sides each including at least one cleat configured to engage the one conductor and secure the respective side thereto. A system for brazing together adjacent pairs of conductors includes a self-securing, three-sided brazing clip having a plurality of cleats formed therein, a comb having a plurality of receptacles structured for retaining respective stator conductors, and electrodes radially aligned with one adjacent pair, where compression of the electrodes sandwiches the brazing clip therebetween.

### BACKGROUND

The present invention is directed to improving manufacture of an electric machine and, more particularly, to a brazing system and clip for reliably positioning objects during a resistance brazing operation.

Various electric machines are assembled by fixing a copper conductor to one or more other conductor(s). For example, in a known “hot staking” process, a current is applied by a pair of welding electrodes, where at least one conductor is sandwiched between and engaged by the electrodes. The combination of heat and compressive force softens the copper conductor(s) and causes conductor deformation. After a period of time, current to the electrodes is terminated and the electrodes are removed. The copper conductor(s) re-harden and form a bond with the other conductor(s). Processing continues until all such weld connections are completed.

Unfortunately manufacturing problems may occur in a hot staking operation. For example, it may be difficult to maintain a constant temperature in a tungsten electrode because the electrode typically becomes hotter with each successive weld when a same current is provided for each weld and insufficient time is provided for electrode cooling between the individual welds. When such electrode becomes sufficiently hot, it may cause damage by penetrating too far when it forcibly contacts the conductor and causes the conductor to completely deform and melt into a U-shape around the electrode. As a result, the weld is faulty and incapable of conducting current in the designed manner.

Brazing is another technique for fixing and thereby electrically connecting a copper conductor to one or more other conductor(s). In a typical brazing operation, a filler material is positioned in the location where the conductors are to be joined, and heat is generated at a connection resistance to a current provided by electrodes, as in the hot staking process. As the temperature increases, the filler material begins to melt, for example at a temperature at least 500° F. lower than the temperature at which the copper conductor(s) begin to deform. As the filler material melts, it flows between the conductors by capillary action.

In a typical brazing operation, a thin, flat brazing ribbon is placed between the faying surfaces of the conductors, the electrodes compress against the conductors, and current is applied through the electrodes and the work piece portions being brazed. After the brazing material melts, the remaining ribbon is withdrawn by hand. The brazing process may be applied as a series of successive events for effecting multiple connections.

In comparison to a hot staking process, brazing advantageously avoids the problem of excessive heat causing conductor deformation. The brazed conductors are not thereby melted so they retain their original shapes, and the respective conductor edges and contours are also not changed by the formation of a weld fillet. Since less heat is required to heat the brazing material to its melting temperature, the brazing process is generally more efficient than a hot staking type welding process.

In a brazing operation, the brazing material must be carefully positioned and held in place at the conductors until the process is completed. Conventionally, the brazing ribbon is inserted manually, which is inefficient and unsafe because it requires that the fingers of the operator be placed undesirably close to the electrodes, which may be pressed onto the conductors with a large force. Brazing clips may be fitted onto conductors to be brazed. However, conventional brazing clips can move from their proper position. In addition, such brazing clips may block or otherwise interfere with an electrode. The brazing ribbon cannot be allowed to contact the electrodes because the electrodes would become permanently welded to the copper conductor.

### SUMMARY

It is therefore desirable to obviate the above-mentioned disadvantages by providing apparatus, system, and method for brazing copper conductor(s).

According to an exemplary embodiment, a method of assembling a stator includes forming a plurality of cleats into a brazing tape, forming a U-shaped clip using the stamped brazing tape, and attaching the U-shaped clip to a stator conductor, where the attached U-shaped clip is self-secured to the conductor by the cleats.

According to another exemplary embodiment, apparatus for connecting a stator conductor pair includes a brazing clip shaped to conform to and fit over one of the conductors, the brazing clip having generally a U-shape with a bottom and two sides, the sides each including at least one cleat configured to engage the one conductor and secure the respective side thereto.

According to a further exemplary embodiment, a system for brazing together adjacent pairs of stator conductor ends includes a self-securing, three-sided brazing clip having a plurality of cleats formed therein, the cleats each structured to engage one of the conductor ends and secure the clip thereto, a comb having a plurality of receptacles structured for retaining respective stator conductors, and first and second electrodes aligned respectively with a radially-inward and a radially-outward side of one of the adjacent pairs of stator conductor ends. Radial movement of one of the electrodes toward the other electrode compresses the one adjacent pair so that the brazing clip is sandwiched therebetween.

The foregoing summary does not limit the invention, which is defined by the attached claims. Similarly, neither the Title nor the Abstract is to be taken as limiting in any way the scope of the claimed invention.

### BRIEF DESCRIPTION OF THE DRAWING FIGURES

The above-mentioned aspects of exemplary embodiments will become more apparent and will be better understood by reference to the following description of the embodiments taken in conjunction with the accompanying drawings, wherein:

FIG. 1 is a schematic view of an exemplary electric machine having a stator core that includes stator windings;

FIG. 2 is a perspective view of a stator core;

FIG. 3A is a cross-sectional view of an exemplary conductor bar used for forming stator windings such as those used in a motor/generator of an electric vehicle; FIG. 3B is a perspective view of an exemplary conductor bar segment having a bent “hairpin” shape for insertion into two slots of a stator body;

FIG. 4 is a partial perspective view of the connection end of an exemplary stator assembly;

FIG. 5 is a schematic top view of apparatus for a brazing operation, according to an exemplary embodiment;

FIG. 6 is a perspective view of a cleated brazing clip, according to an exemplary embodiment;

FIG. 7 is a perspective view of a cleated brazing clip, according to an exemplary embodiment;

FIGS. 8A-8C show three embodiments of brazing clips before they are shaped to fit over conductors;

FIG. 9 is a schematic top view of apparatus for a brazing operation, according to an exemplary embodiment; and

FIG. 10 is a schematic top view of a multiple position comb electrode, according to an exemplary embodiment.

Corresponding reference characters indicate corresponding or similar parts throughout the several views.

### DETAILED DESCRIPTION

The embodiments described below are not intended to be exhaustive or to limit the invention to the precise forms disclosed. Rather, the embodiments are chosen and described so that others skilled in the art may appreciate and understand the principles and practices of these teachings.

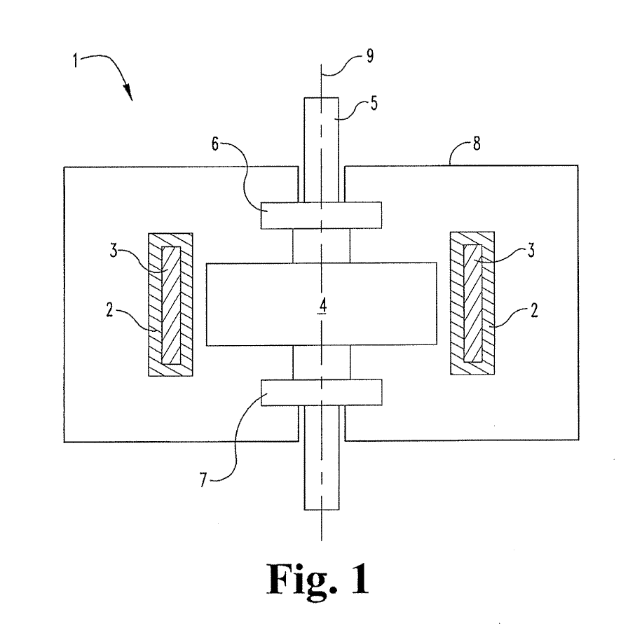

FIG. 1 is a schematic view of an exemplary electric machine 1 having a stator core 2 that includes stator windings 3 such as one or more coils. An annular rotor body 4 may also contain windings and/or permanent magnets and/or conductor bars such as those formed by a die-casting process. Rotor body 4 is part of a rotor that includes an output shaft 5 supported by a front bearing assembly 6 and a rear bearing assembly 7. Bearing assemblies 6, 7 are secured to a housing 8. Typically, stator core 2 and rotor body 4 are substantially cylindrical in shape and are concentric with a central longitudinal axis 9. Electric machine 1 may be a motor/generator such as an automotive alternator/starter. Housing 8 may have a plurality of fins (not shown) spaced apart from one another on a housing external surface for dissipating heat produced in stator windings 3.

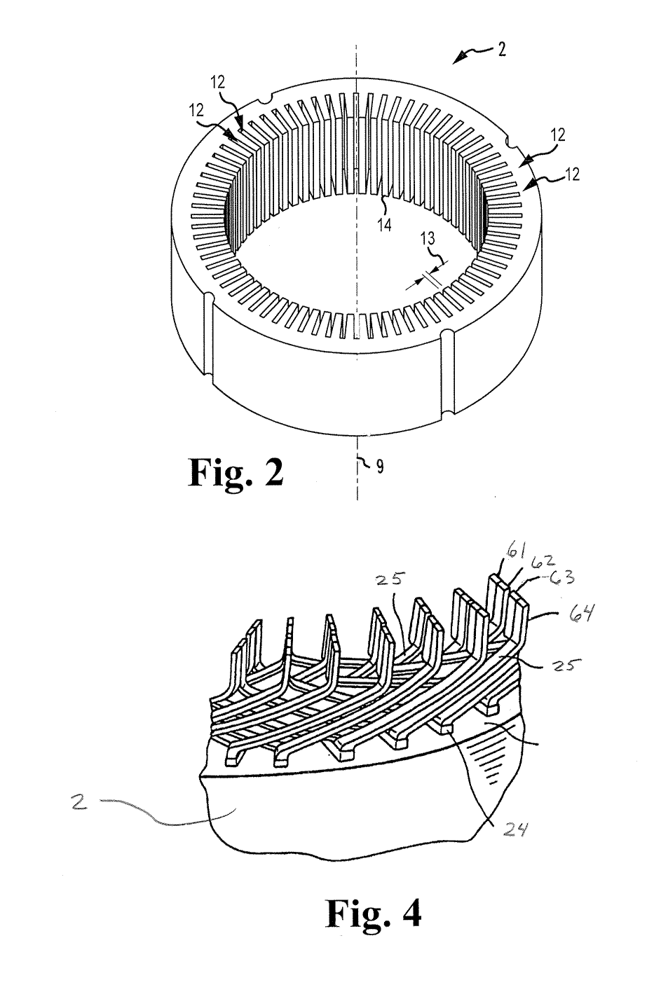

FIG. 2 is a perspective view of a substantially columnar stator core 2 having a center axis 9. In an exemplary embodiment, stator core 2 has 108 radially and longitudinally extending slots 12 each extending radially outward of a circumferential inner surface 14 and each having a nominal width 13. In various embodiments, the radially-inner openings of slots 12 may be narrowed to a width less than nominal width 13. Slots 12 are shown by example extending axially between axial ends of stator core 2. Stator core 2 may be formed as a stack of individual steel laminations that have been coated with a thin layer of insulation material.

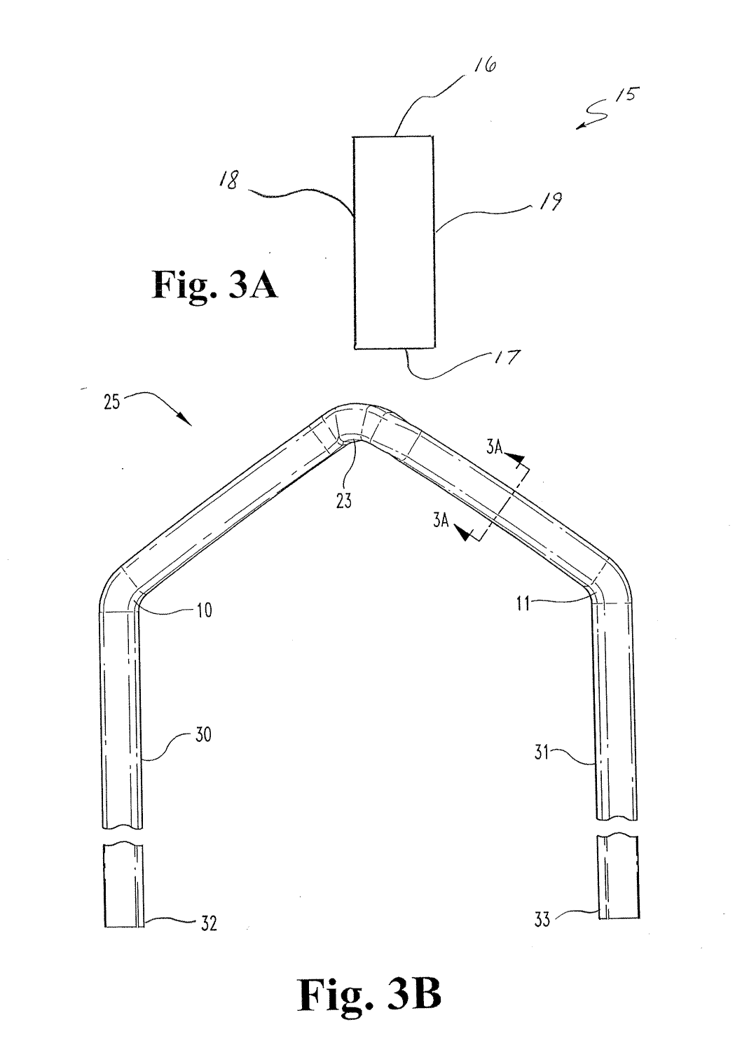

FIG. 3A is a cross-sectional view of an exemplary conductor bar 15 used for forming stator windings such as those used in a motor/generator of an electric vehicle. Conductor bar 15 may be formed of copper, aluminum, or other conductive material. For example, in order to provide a higher output for a given motor size, solid copper wire may be selected because of its excellent conductivity and may have a substantially rectangular cross section, thereby maximizing the amount of copper per unit volume in a stator winding 3. Conductor bar 15 has an approximately rectangular profile with two long surfaces 18, 19, for example 0.120 inches, and two short surfaces 16, 17, for example 0.060 inches.

FIG. 3B is a perspective view of an exemplary conductor bar segment 25 having a bent “hairpin” shape for insertion into two slots 12 of stator body 2. A first insertion portion 30 and a second insertion portion 31 extend essentially axially outward from respective distal ends 32, 33 of conductor bar segment 25. Bends 10, 11 are respectively formed to define obtuse angles at axially outward ends of insertion portions 30, 31, so that the hairpin legs meet to form an obtuse angle defining a center apex portion 23 of conductor segment 25. After the end turn portion has been formed into its desired shape, conductor bar segment 25 may be coated with an electrically insulating and/or other protective coating. An individual conductor bar segment 25 may for example be inserted into stator 2 so that end 32 is placed into a slot 12 at one radial slot position and end 33 is placed into a slot 12 at another radial position. Although shown with tapered portions, conductor ends 32, 33 may alternatively be formed without features.

Typically, a number of hairpin conductor segments are inserted into slots of a stator core so that the apexes of all hairpins are on one axial end of the stator and the conductor ends are all on the other axial end. FIG. 4 is a partial perspective view of the connection end of an exemplary stator assembly. Each stator slot may include one or more slot liners 24 that prevent respective hairpin segments 25 from contacting stator core 2 and/or other hairpin segments 25. When a group of hairpin segments 25 have been inserted and seated into respective pairs of slots, the protruding portions of legs 30, 31 (e.g., FIG. 3B) are grasped and bent according to a chosen wiring diagram. As a result, pairs of conductor ends are placed into a connection position. In particular, a short side 16 of a leg of one hairpin 25 is placed adjacent to a short side 17 of a leg of a second hairpin 25, thereby forming an adjacent pair to be connected by brazing or welding. For example, a conductor end 61 placed in proximity to a conductor end 62 forms an adjacent pair, and a conductor end 63 placed in proximity to a conductor end 64 forms another adjacent pair.

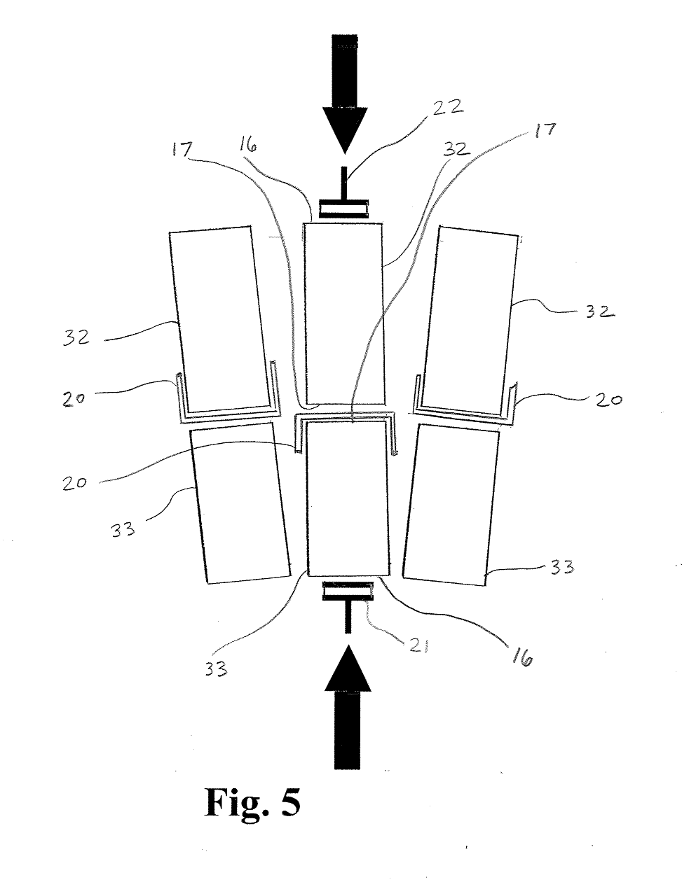

FIG. 5 is a schematic top view of apparatus for a brazing operation, according to an exemplary embodiment. When hairpin conductors 25 have been installed into stator core 2, a plurality of adjacent pairs are aligned so that a short cross-sectional side 16 or 17 of one end portion 32 or 33 is in close proximity to a short cross-sectional side 16 or 17 of another end portion 32 or 33. The two hairpins 25 of each hairpin pair are aligned substantially radially. A three-sided brazing clip 20 is attached to one hairpin 25 of each adjacent pair. Although clips 20 are shown as being alternately placed on the radially-inner hairpin 25 and radially-outer hairpin 25, either hairpin 25 of an adjacent pair may have an attached clip 20. When all adjacent pairs have an attached clip 20, the corresponding stator core is secured for brazing. A radially inner brazing electrode 21 and a radially outer brazing electrode 22 are pressed against radially distal short sides 16 of an adjacent pair, so that brazing clip 20 is sandwiched between radially proximate short sides 17. As force is applied to the conductors from electrodes 21, 22, a voltage is applied across electrodes 21, 22, causing a current to flow through the conductor ends 32, 33. Electrical current is applied by a brazing power supply such as a mid-frequency inverter type machine. For example, a current of about seven thousand amperes may be applied for one-quarter second. Generally, the brazing current may be around 10,000 amps, and may be applied for about 1 second or less, thereby producing sufficient heat to melt the brazing material. The electric current causes the copper conductors and clip to heat up. The clip 20 has a melting temperature of about 1420° F., whereas copper hairpin conductors 25 have a higher melting temperature of about 2000° F., such that only the brazing material liquefies during the brazing operation. As the brazing material liquefies, the phosphorous component cleans the copper and the brazing alloy flows by capillary action into the spaces between the conductor ends being joined.

The electrical current creates heat at the conductor interface that includes clip 20, whereby brazing clip 20 melts and ends 32, 33 of the adjacent pair are resistance brazed to one another. The amount of radially-directed force pressing adjacent ends 32, 33 together, and/or the current level(s) and duration may be adjusted to optimize the quality of the brazed joint. The force being applied by electrodes 21, 22 is typically maintained for a period of time after the current is terminated. Thereafter, electrodes 21, 22 are removed and the brazing material hardens and forms a bond with the conductor ends being joined. For example, the brazing material may require 0.25 to 0.5 seconds to harden and electrodes 21, 22 may remain in biasing force position for one second.

The alignment of short sides 16, 17 of adjacent hairpin ends 32, 33, and the retention of brazing clip 20 on one hairpin 25 of each adjacent pair are each subject to problems. For example, when individual brazing clips 20 are placed onto a hairpin 25 for each of 108 total adjacent pairs to be joined, and when such subassembly is handled and moved within a manufacturing location, some of the 108 brazing clips 20 may be dislodged. In addition, the two adjacent hairpin ends 32, 33 of an adjacent pair may become misaligned before or during brazing. As a result, unless care is taken during manufacturing, one or more brazed joints may be defective. In such a case, repair is difficult, and defective connection joints reduce performance and decrease machine efficiency.

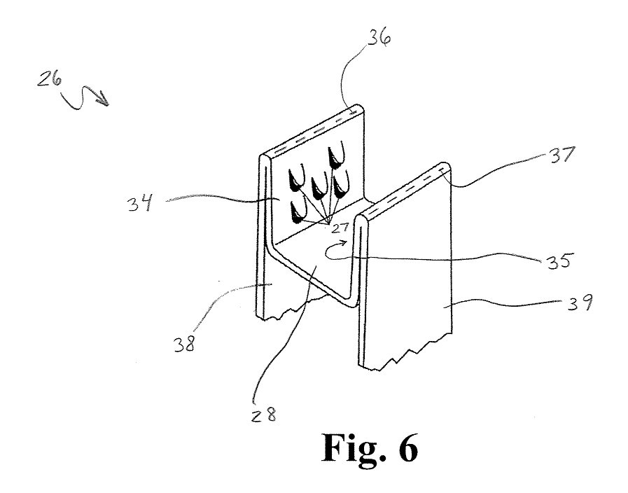

FIG. 6 is a perspective view of a cleated brazing clip 26, according to an exemplary embodiment. A brazing tape is punched to form cleats 27, and is then formed into a three-sided shape. For example, the brazing tape may be about 0.004 inch thick and have a width of about 0.25 inch. A bottom portion 28 has a width dimension slightly greater than the width of a short side 16, 17 of conductor 15 (FIG. 3A). Inner side walls 34, 35 each contain an array of cleats 27. Side walls 34, 35 are folded back on themselves at respective bends 36, 37, thereby creating respective pull tabs 38, 39. Bends 36, 37 may each be perforated. In an exemplary embodiment, brazing clip 26 may be formed of a thin brazing material, for example an alloy of copper, phosphorus and silver. There are a large number of commercially available brazing alloys that may be suitable for use with the present invention, and one suitable alloy is known by those skilled in the art as BCuP5, which has a composition of about 15% silver, 5% phosphorous, 80% copper and trace amounts of other materials. Alternatively, the brazing tape may be AgCuP or other suitable material. In use, cleats 27 keep brazing clip 26 secured in proper position on conductor end 32 or 33 prior to the brazing operation. Pull tabs 38, 39 may be held while electrodes 21, 22 are moved toward one another into the brazing position, and may then be pulled slightly to be broken away at folds 36, 37 during brazing. In this manner, a consistent brazed joint is obtained.

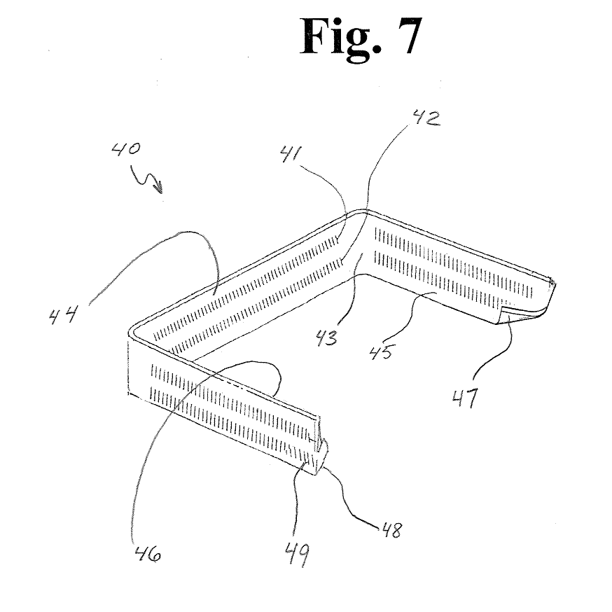

FIG. 7 is a perspective view of a cleated brazing clip 40, according to an exemplary embodiment. A brazing tape is punched to form a first series of cleats 41 and a second set of cleats 42. Cleats 41, 42 may have a serrated profile to provide a number of very sharp edges, and may be formed in rows. Corner spaces 43 are provided without cleats to assure structural integrity when the brazing tape is formed into a clip. A bottom portion 44 has a length dimension slightly greater than the width of a short side 16, 17 of conductor 15 (FIG. 3A). Inner side walls 45, 46 each contain cleat series 41, 42, and also contain an end cleat or inwardly bent tab that engages the conductor of an armature to hold it in place. Side wall 45 has an inwardly bent end corner 47 formed to be a pointed and sharp cleat. This allows corner cleat 47 to pierce the surface of conductor 15 and thereby “dig in” to the copper conductor and prevent movement. Similarly, cleat or inwardly bent tab 47 may also be positioned in an indentation (not shown) previously formed in conductor 15 to thereby resist movement of brazing clip 40 by engagement of cleat 47 with such indentation. In like manner, side wall 46 may have an inwardly bent corner 48 formed to be symmetrical respecting cleat 47. Cleat or inwardly bent tab(s) 47, 48 may also biasingly engage conductor 15 to thereby increase the bearing pressure exerted between brazing clip 40 and conductor 15. For example, when clip 40 is formed with only one bent corner cleat 47, engagement of cleat 47 with conductor 15 forms a spring that exerts pressure on the side of conductor 15 opposite cleat 47 to thereby resist movement of brazing clip 40 on conductor 15 by frictional forces. In such a case, edge cleats 49 may be formed to be skewed respecting cleat series 41, 42 in order to create resistance to twisting torque and lateral movement. In a given embodiment, the number and shapes of cleats is a design variable. Since there are typically four corners on the material that is used to form the clip, there can be four cleats formed using bent corners.

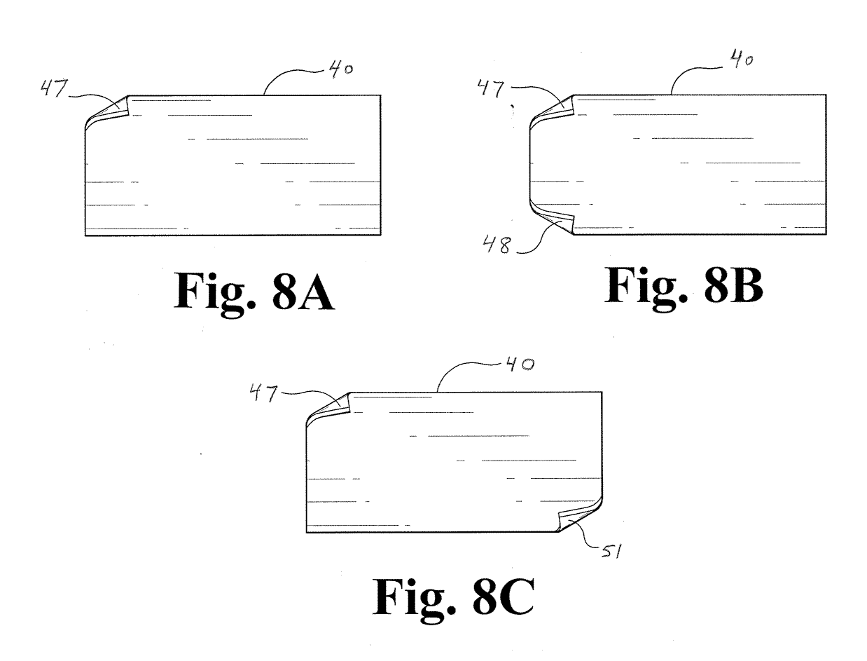

Additional features may be formed in a three-sided brazing clip. For example, in certain embodiments it may be desirable to form a depression on the conductors 15, to assist the clip in remaining in its installation position. In other embodiments, a clip having a single cleat 47 in the form of a bent corner may be sufficient. FIGS. 8A-8C show three embodiments of clips 40 before they are formed into the shape to fit over the conductors. In FIG. 8A, a clip 40 is shown having a single cleat 47. FIG. 8B illustrates an option in which two cleats 47, 48 are provided. FIG. 8C shows a clip 40 having two cleats 47, 51. One of skill in the art would recognize other configurations within the scope of these teachings. Advantageously, the inventive clips with cleats provided by these teachings are not limited to use with any specifically shaped brazing clip. Rather, the clips can be formed in any of a wide variety of shapes and still be formed with the inventive cleats.

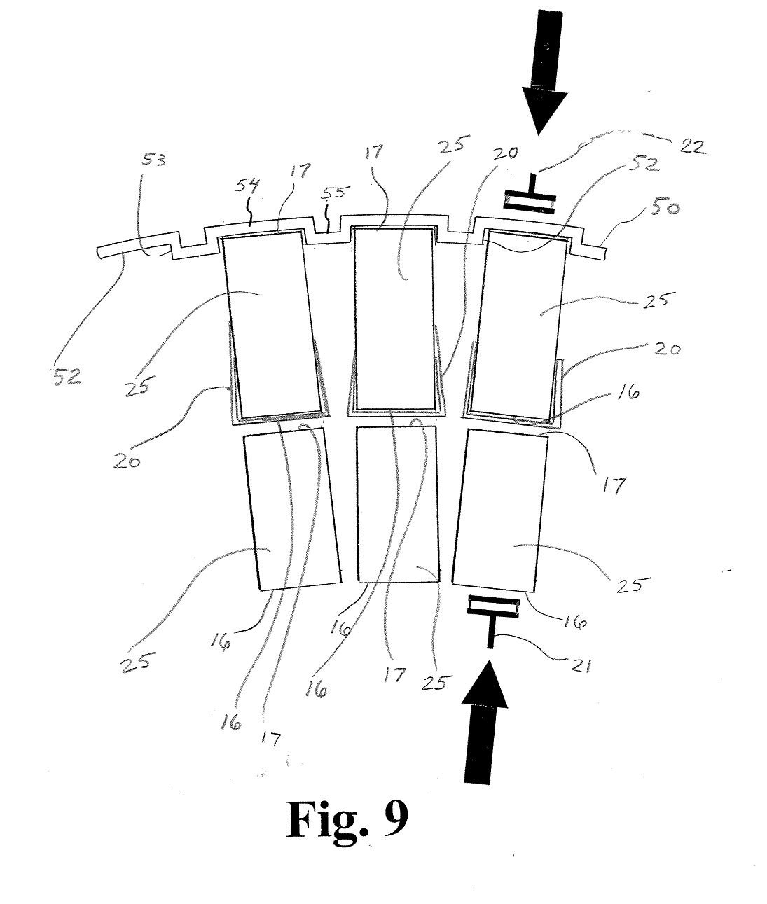

FIG. 9 is a schematic top view of apparatus for a brazing operation, according to an exemplary embodiment. As described above regarding FIG. 5, when hairpin conductors 25 have been installed into stator core 2, a plurality of adjacent pairs are aligned so that a short cross-sectional side 16 or 17 of one end portion 32 or 33 is in close proximity to a short cross-sectional side 16 or 17 of another end portion 32 or 33, and is aligned substantially radially. A three-sided brazing clip 20 is attached to one hairpin 25 of each adjacent pair being brazed together. A comb 50 is used to temporarily retain the radial outer edge 17 of the radially outer hairpin 25, for each adjacent pair. For example, comb 50 may contain five slots 52, or any appropriate number of slots 52, each sized to have a circumferential width slightly greater than the width of a short cross-sectional side 16 or 17. Comb 50 is curved in correspondence with the curvature of the array of adjacent hairpin pairs. Comb 50 may be structured as an electrode, or a separate radially-outer electrode 22 may be used. For example, radially-outer electrode 22 may be axially outward of comb 50 so that when comb 50 secures a number of radially-outer hairpins 25, electrode 22 may be moved circumferentially to be aligned with and then contact an individual hairpin side 16 or 17.

In an exemplary embodiment, comb 50 receives and secures radially outer sides of hairpin conductors 25, and inner electrode 21 moves circumferentially along the radially-inner portion of the adjacent pairs to sequentially resistance braze one pair at a time. A rotary indexer having a servomotor, such as an x-y-z table, may be used to position a moving electrode 21. Typically electrodes 21, 22 contain about 25% tungsten, which acts to partially block heat transfer to water cooling channels, but such electrodes may be safely operated to remain at a temperature that does not damage contacting surfaces 16, 17. For example, a mid-frequency inverter type of brazing machine (not shown) may supply current in bursts of about 0.25 second, but the total machine time between successive brazes may be about ten to twenty seconds when a stabilizing period, an unclamping time, an electrode rotation time, an indexing time, and a reclamping time are accounted for. In an alternative embodiment, radially inner electrode 21 may have a wide coverage so that it contacts more than one hairpin 25, and radially outer electrode 22 may be moved circumferentially for sequentially clamping, brazing, and unclamping an outer hairpin surface 16 or 17. The inner edges 53 of comb slots 52 may be curved or beveled to avoid unnecessarily torqueing or damaging hairpins 25. Secure engagement of comb 50 with hairpins 25 allows radially outer electrode 22 to more quickly disengage from a radially outer surface 16 or 17 while still allowing the freshly brazed joint to stabilize, whereby sequential electrode positioning time is decreased. Comb portions 54 may incorporate individual electrode elements, as discussed further below. Comb teeth 55 may incorporate cooling channels, insulating portions, and/or alignment pins, where appropriate.

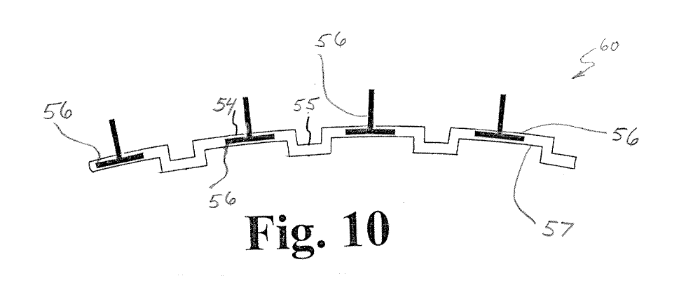

FIG. 10 is a schematic top view of a multiple position comb electrode 60, according to an exemplary embodiment. Comb receptacle portions 54 are separated from one another by teeth 55, and may each contain a brazing electrode 56. Electrodes 56 may be flush with a receptacle back surface 57 or they may be recessed slightly. When electrodes 56 are recessed, the intermediate material between surfaces 57 and electrodes 56 may be formed of an electrically conductive metal such as copper. When electrodes 56 are flush with respective surfaces 57, the material of comb 60, in whole or in part, may have properties of electrical insulation, heat conductance, rigidity, flexibility, and others. Comb 60 may alternatively be formed with a concave curvature for securing and providing electrodes to radially-inward hairpin surfaces 16 or 17. For example, a brazing operation may utilize one or more inner and outer combs 60 for sequentially brazing individual adjacent hairpin pairs without moving electrodes, by sequentially applying the brazing electrical current to individual ones of electrodes 56. In example, more than one adjacent pair may be brazed at the same time when both inner and outer comb electrodes 60 are used. Additionally, brazing of individual adjacent pairs may be performed in a skipping order, whereby freshly brazed joints are allowed to stabilize and cool while brazing continues for an adjacent pair located several slots away from the fresh braze. In such a case, the compression of electrodes being pushed toward one another may be maintained after the brazing electrical current has been turned off, allowing the freshly brazed joint to stabilize and harden rather than becoming separated. The melted brazing clip 20, 26, 40 may thereby be more accurately formed into a desired fillet around the joint. In a further example, a comb electrode 60 may secure the radially-outer hairpin surfaces 16 or 17 while radially-inner electrode 21 (e.g., FIG. 5) is sequentially stepped from one radially-inner hairpin surface 16 or 17 to the next. The amount of radially-directed force pressing adjacent ends 32, 33 (e.g., FIG. 5) together, and/or the electrical current level(s) and duration may be adjusted to optimize the quality of the brazed joint.

While various embodiments incorporating the present invention have been described in detail, further modifications and adaptations of the invention may occur to those skilled in the art. However, it is to be expressly understood that such modifications and adaptations are within the spirit and scope of the present invention.

What is claimed is:

1. A method of assembling a stator, comprising:
forming a plurality of cleats into a brazing tape;
forming a U-shaped clip using the stamped brazing tape; and
attaching the U-shaped clip to a stator conductor;
wherein the attached U-shaped clip is self-secured to the conductor by the cleats.

2. The method of claim 1, further comprising:
clamping two stator conductors together with a pair of electrodes, one of the clamped conductors having the attached U-shaped clip; and
applying current through the electrodes, thereby brazing together the clamped conductors.

3. The method of claim 2, further comprising repeating the clamping and applying of current for each of a plurality of clamped stator conductors.

4. The method of claim 2, wherein the clamping includes the electrodes aligning the two stator conductors with one another.

5. The method of claim 2, wherein one of the electrodes comprises a comb structured for retaining respective radially-outer portions of a plurality of stator conductors.

6. The method of claim 5, wherein the comb comprises a plurality of slots each having an individual electrode.

7. The method of claim 1, wherein the forming of the U-shaped clip results in each clip side having a length about twice the length of the end of the U-shape.

8. The method of claim 1, wherein the cleats are formed along each clip side of the U-shape.

9. The method of claim 1, wherein the cleats are formed along the bottom of the U-shape.

10. The method of claim 1, wherein the forming of cleats is performed by stamping.

11. The method of claim 1, further comprising:
folding at least one side of the U-shaped clip back about 180 degrees to extend away from the open direction of the U-shape; and
pulling the extended portion of the clip during brazing.

12. Apparatus for connecting a stator conductor pair, comprising a brazing clip shaped to conform to and fit over one of the conductors, the brazing clip having generally a U-shape with a bottom and two sides, the sides each including at least one cleat configured to engage the one conductor and secure the respective side thereto.

13. Apparatus of claim 12, wherein the cleats are perforations.

14. Apparatus of claim 12, wherein the cleats are formed by bending respective portions of the sides toward one another.

15. Apparatus of claim 12, wherein at least one of the sides terminates in a bent corner section that engages the one conductor and thereby restricts movement of the clip from a seated position on the one conductor.

16. A system for brazing together adjacent pairs of stator conductor ends, comprising:
a self-securing, three-sided brazing clip having a plurality of cleats formed therein, the cleats each structured to engage one of the conductor ends and secure the clip thereto;
a comb having a plurality of receptacles structured for retaining respective stator conductors; and
first and second electrodes, aligned respectively with a radially-inward and a radially-outward side of one of the adjacent pairs of stator conductor ends;
wherein radial movement of one of the electrodes toward the other electrode compresses the one adjacent pair so that the brazing clip is sandwiched therebetween.

17. The system of claim 16, wherein the first electrode is disposed in the comb.

18. The system of claim 17, wherein the first electrode comprises a plurality of individual electrodes disposed in respective ones of the receptacles.

19. The system of claim 16, wherein radial disengaging movements of the comb and the first electrode away from the one adjacent pair are independent of one another.

20. The system of claim 16, wherein the comb is curved in correspondence with curvature of an array of the adjacent pairs of stator conductor ends.
